(19) United States
(12) Patent Application Publication
(10) Pub. No.: US 2010/0283812 A1
(43) Pub. Date: Nov. 11, 2010

(54) RECORDING APPARATUS, COMPUTER-READABLE STORAGE MEDIUM, COMPUTER SYSTEM, AND RECORDING METHOD

(75) Inventor: Toyohiko MITSUZAWA, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION, Tokyo (JP)

(21) Appl. No.: 12/838,097

(22) Filed: Jul. 16, 2010

Related U.S. Application Data
(63) Continuation of application No. 10/725,332, filed on Dec. 2, 2003.

(30) Foreign Application Priority Data
Dec. 2, 2002 (JP) 2002-350403

(51) Int. Cl. B41J 29/38

(52) U.S. Cl. 347/16

(57) ABSTRACT

A recording apparatus comprises at least two medium supply sections, each of the medium supply sections being provided for supplying a recording medium, and at least two recording sections, each of the recording sections being provided in correspondence with one of the medium supply sections and for recording on the recording medium supplied by the corresponding medium supply section.

### CROSS-REFERENCE TO RELATED APPLICATIONS

This application is a Rule 53(b) Continuation of U.S. application Ser. No. 10/725,332 filed Dec. 2, 2003 and which claims priority upon Japanese Patent Application No. 2002-350403 filed Dec. 2, 2002, which is herein incorporated by reference. The above noted applications are incorporated herein by reference in their entirety.

### BACKGROUND OF THE INVENTION

1. Field of the Invention

The present invention relates to recording apparatuses including a plurality of recording sections for recording on a recording medium and a medium supply section for supplying the recording medium, to computer-readable storage media storing a computer program for making this recording apparatus perform recording, to computer systems including this recording apparatus, and to recording methods for recording using this recording apparatus.

2. Description of the Related Art

Conventionally, as recording apparatuses including a plurality of recording sections, an inkjet printer is known that includes print heads, serving as recording sections, that sandwich a carry path over which print paper serving as the recording medium is carried and which oppose the front and the back of the print paper, and that allows printing on both sides of the print paper (see, for example, JP H5-261979A). This inkjet printer prints on the front and back of one sheet of print paper supplied over a carry path from a paper supply section by ejecting ink from print heads that are arranged on the front side and the back side of the print paper.

However, even though this inkjet printer has two print heads, these print heads print on one sheet of print paper supplied from one paper supply section. Therefore, there is the problem that it cannot print on a plurality of print papers at the same time.

### SUMMARY OF THE INVENTION

In view of this and other problems, it is an object of the present invention to provide a recording apparatus that can record on a plurality of recording media in correspondence with a plurality of recording sections of the apparatus, as well as a computer-readable storage medium storing a computer program for making this recording apparatus perform recording, a computer system including this recording apparatus, and a recording method for recording using this recording apparatus.

An aspect of the present invention is a recording apparatus comprising: at least two medium supply sections, each of the medium supply sections being provided for supplying a recording medium; and at least two recording sections, each of the recording sections being provided in correspondence with one of the medium supply sections and for recording on the recording medium supplied by the corresponding medium supply section.

Features of the present invention other than the above will become clearer through the accompanying drawings and the following description.

### BRIEF DESCRIPTION OF THE DRAWINGS

In order to facilitate further understanding of the present invention and the advantages thereof, reference is now made to the following description taken in conjunction with the accompanying drawings wherein:

FIG. 1 is a perspective view showing an overview of a color printer according to a first embodiment of the present invention;

FIG. 2 is a perspective view showing the color printer in FIG. 1 in a state in which the carriage has been moved;

FIG. 3 is a diagrammatic view illustrating a suction mechanism in a platen;

FIG. 4 is a cross-sectional view taken along line A-A in FIG. 1;

FIG. 5 is an explanatory diagram illustrating nozzle rows in print heads;

FIG. 6 is a diagram illustrating an arrangement of nozzles for adjacent print heads;

FIG. 7 is a block diagram showing a configuration of a printing system provided with a color printer;

FIG. 8 is a block diagram showing a configuration of an image processing unit;

FIG. 9 is a perspective view showing an overview of a color printer according to a second embodiment;

FIG. 10 is a diagrammatic cross-sectional view illustrating a structure the color printer shown in FIG. 9;

FIG. 11 is a diagrammatic cross-sectional view showing a modified example of the second embodiment; and

FIG. 12 is a perspective view showing an overview of a color printer according to a third embodiment.

### DETAILED DESCRIPTION OF THE INVENTION

At least the following matters will be made clear by the description in the present specification and the accompanying drawings.

An aspect of the present invention is a recording apparatus comprising: at least two medium supply sections, each of the medium supply sections being provided for supplying a recording medium; and at least two recording sections, each of the recording sections being provided in correspondence with one of the medium supply sections and for recording on the recording medium supplied by the corresponding medium supply section.

With such a recording apparatus, it becomes possible to supply a recording medium for each of the recording sections with the medium supply sections that are arranged in correspondence with each of the recording sections. Therefore, it becomes possible to perform recording with the corresponding recording sections on the recording media that are supplied by the respective medium supply sections, and to record simultaneously on a plurality of recording media.

In the recording apparatus, it is preferable that the recording apparatus further comprises at least two controllers, each of the controllers being provide in one-to-one correspondence with one of the recording sections and for controlling the corresponding recording section.

With this recording apparatus, it becomes possible to perform different controls for each of the recording sections with the controllers corresponding to each of the recording sections, and to perform recording according to different control for each of the recording sections.

In the recording apparatus, it is preferable that the recording apparatus further comprises at least two information generators, each of the information generators being provide in one-to-one correspondence with one of the recording sections and for generating recording information for the corresponding recording section, wherein each recording section performs recording based on the recording information.

With this recording apparatus, it becomes possible to perform recording with each of the recording sections based on recording information that has been generated by information generators corresponding to the recording sections. Therefore, if different recording information is generated by each of the information generators, then it becomes possible to carry out different recording with each of the recording sections, based on the different recording information.

In the recording apparatus, it is preferable that the recording sections perform recording on the recording medium supplied from the corresponding medium supply sections in the order in which the recording information is generated by the information generators corresponding to each of the recording sections.

With this recording apparatus, the recording is performed by the recording sections corresponding to the information generators in the order in which the recording information is generated by the information generators. Therefore, it becomes possible to perform recording in order starting with the recording section for which the recording information has been generated first. In this way, the recording apparatus does not wait until the recording information for all recording sections has been generated, but starts recording with the recording section for which the recording information has been generated. Therefore, it becomes possible to shorten the recording time by recording in the order in which the recording information is generated.

In the recording apparatus, it is preferable that each of the recording sections is capable of performing recording in different recording modes.

With this recording apparatus, it is possible to record with recording modes that are different for each recording section, and therefore, it becomes possible to simultaneously carry out recordings in different recording modes with the each of the recording sections. Consequently, even when recording information for recording is generated according to various recording modes, it becomes possible to perform recording in a short time, because it is possible to record with each of the recording sections independently. Here, if, for example, “recording on the recording medium” means “printing on print paper”, then “recording mode” refers to print modes with different resolutions of the printed image, with different carry amounts of the medium, and so forth; that is, it refers to a so-called high-speed mode, a high-quality mode, and a high-precision mode, for example.

In the recording apparatus, it is preferable that: each of the medium supply sections comprises a driving section for driving the corresponding medium supply section; and when supplying a recording medium that is arranged across at least two of the medium supply sections, the driving sections of those medium supply sections across which the recording medium is arranged operate together to supply the recording medium.

With this recording apparatus, a recording medium that is arranged across a plurality of medium supply sections is supplied by cooperation of the driving sections of the medium supply sections across which the recording medium is arranged, and therefore, the recording medium can be supplied reliably by the medium supply sections.

In the recording apparatus, it is preferable that: each of the medium supply sections comprises a supply section for supplying the recording medium, and a driving section for driving that supply section; and when supplying a recording medium that is arranged across the supply sections of at least two of the medium supply sections, the supply sections across which the recording medium is arranged are driven by the driving section for driving one of those supply sections.

With this recording apparatus, a recording medium that is arranged across a plurality of medium supply sections is supplied by driving the supply sections with the driving section of one of the medium supply sections across which the recording medium is arranged, and therefore, it becomes possible to supply the recording medium with a single driving force. That is to say, misalignment in the recording medium that occurs, for example, due to discrepancies in the driving force generated by each of the driving sections when supplying a recording medium with a plurality of driving sections tends not to occur, and it becomes possible to supply the recording medium accurately.

In the recording apparatus, it is preferable that: each of the medium supply sections comprises a driving force blocking section that blocks a transmission path for transmitting driving force caused by the driving sections; and when supplying a recording medium with one of the supply sections across which the recording medium is arranged, the driving force blocking section of the medium supply section including the other supply section blocks the transmission path for transmitting the driving force caused by the driving section of that medium supply section.

With this recording apparatus, when supplying the recording medium with one driving section, the driving force transmission path of the other driving section is blocked. Therefore, when supplying the recording medium with a single driving section, the influence from the other driving section is reliably eliminated, and it becomes possible to supply the recording medium in a favorable manner.

In the recording apparatus, it is preferable that each of the recording sections has a recording portion row in which a plurality of recording portions are arranged in a row with equal pitch in a supply direction in which the recording medium is supplied; and as for two recording sections that are arranged next to each other in a direction orthogonal to the supply direction, a distance between the rearmost recording portion, in the supply direction, of the recording portion row of one of the two recording sections and the foremost recording portion, in the supply direction, of the recording portion row of the other of the two recording sections is equal to the pitch.

With this recording apparatus, it is possible to record with the recording sections individually by letting each of the recording sections operate independently, and it also becomes possible to treat the recording portion rows of adjacent recording sections as one continuous recording portion row by letting the adjacent recording sections operate with appropriate synchronization. That is to say, when recording on a region that is larger than the recording portion row of one recording section, it becomes possible to carry out the recording on a large region in a short time by recording with a continuous recording portion row made of the recording portion rows of a plurality of recording sections.

Another aspect of the present invention is a recording apparatus comprising:

at least two medium supply sections, each of the medium supply sections being provided for supplying a recording medium;

at least two recording sections, each of the recording sections being provided in correspondence with one of the medium supply sections and for recording on the recording medium supplied by the corresponding medium supply section;

at least two controllers, each of the controllers being provide in one-to-one correspondence with one of the recording sections and for controlling the corresponding recording section; and

at least two information generators, each of the information generators being provide in one-to-one correspondence with one of the recording sections and for generating recording information for the corresponding recording section,

wherein each recording section performs recording based on the recording information,

wherein the recording sections perform recording on the recording medium supplied from the corresponding medium supply sections in the order in which the recording information is generated by the information generators corresponding to each of the recording sections,

wherein each of the recording sections is capable of performing recording in different recording modes,

wherein each of the medium supply sections comprises a driving section for driving the corresponding medium supply section,

wherein, when supplying a recording medium that is arranged across at least two of the medium supply sections, the driving sections of those medium supply sections across which the recording medium is arranged operate together to supply the recording medium,

wherein each of the recording sections has a recording portion row in which a plurality of recording portions are arranged in a row with equal pitch in a supply direction in which the recording medium is supplied, and

wherein, as for two recording sections that are arranged next to each other in a direction orthogonal to the supply direction, a distance between
the rearmost recording portion, in the supply direction, of the recording portion row of one of the two recording sections and
the foremost recording portion, in the supply direction, of the recording portion row of the other of the two recording sections
   is equal to the pitch.

With this recording apparatus, a recording medium is supplied to each of the recording sections by the medium supply sections arranged in correspondence to the recording sections, the recording information is generated by information generators corresponding to the recording sections, and different recordings in different recording modes can be carried out in the order in which the recording information is generated by individually controlling the recording sections with the controllers corresponding to the recording sections. In this case, a recording medium that is arranged across a plurality of medium supply sections is cooperatively supplied by the driving sections of the medium supply sections across which the recording medium is arranged, and therefore, the recording medium can be supplied reliably by the medium supply sections. Further, by letting adjacent recording sections operate with the appropriate synchronization, it becomes possible to carry out the recording on a large region in a short time by recording with a continuous recording portion row made of the recording portion rows of a plurality of recording sections.

It is also possible to provide a computer-readable storage medium having recorded thereon a computer program for a recording apparatus comprising: at least two medium supply sections, each of the medium supply sections being provided for supplying a recording medium; and at least two recording sections, each of the recording sections being provided in correspondence with one of the medium supply sections and for recording on the recording medium supplied by the corresponding medium supply section, wherein the computer program causes the recording apparatus to realizing a function of making each of the recording sections record on the recording medium supplied from each of the corresponding medium supply sections.

It is also possible to provide a computer system comprising: a computer; and a recording apparatus connected to the computer and including: at least two medium supply sections, each of the medium supply sections being provided for supplying a recording medium; and at least two recording sections, each of the recording sections being provided in correspondence with one of the medium supply sections and for recording on the recording medium supplied by the corresponding medium supply section.

It is also possible to provide a method for performing recording with a recording apparatus including: at least two medium supply sections, each of the medium supply sections being provided for supplying a recording medium; and at least two recording sections, each of the recording sections being provided in correspondence with one of the medium supply sections and for recording on the recording medium supplied by the corresponding medium supply section, wherein the method comprising: a step of supplying the recording medium to the recording sections from the corresponding medium supply sections; and a step of recording with those recording sections on the supplied recording medium.

### ===Example Overview of Recording Apparatus===

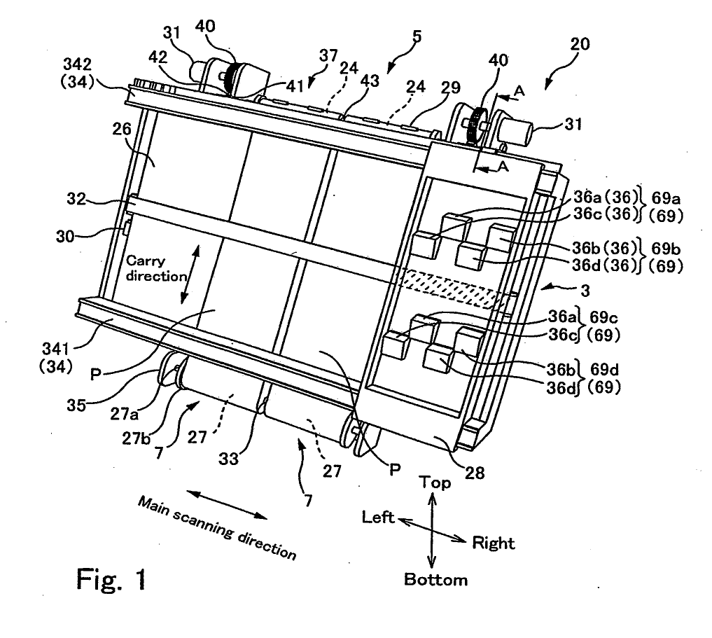

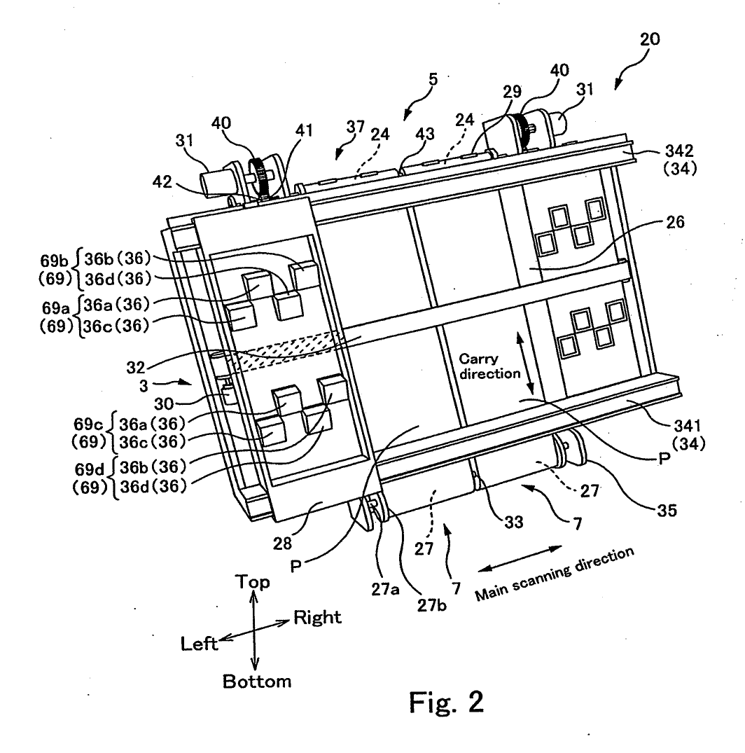

FIGS. 1 and 2 are perspective views showing an overview of a color inkjet printer (referred to as “color printer” in the following) 20 according to a first embodiment of a recording apparatus. This color printer 20 is an inkjet printer capable of outputting color images that forms images by forming dots by ejecting colored ink of, for example, the six colors—cyan (C), light cyan (LC), magenta (M), light magenta (LM), yellow (Y), and black (K)—on various kinds of recording media, such as print paper. It should be noted that the colored inks are not limited to the above-noted six colors, and it is also possible to use, for example, dark yellow (DY) or the like. The color printer 20 is adapted, for example, to roll paper in which print paper serving as the recording medium is wound up in roll-shape, but also to relatively large single-sheet print paper, such as A0 or B0 size paper according to the JIS standard. In the example shown in FIGS. 1 and 2, the color printer 20 is provided with roll paper. In FIGS. 1 and 2, the position of the carriage 28 provided on the color printer 20 is different. This carriage 28 will be explained further below.

As shown in the figures, the color printer 20 includes a recording section 3 that ejects ink in order to print on the roll paper P, and a print paper carrying section 5 for carrying the print paper.

The recording section 3 includes a carriage 28, a carriage motor 30 for making the carriage 28 move (or “scan”), a pull belt 32 made of metal, and two guide rails 34 for guiding the carriage 28. A plurality of print heads 36 serving as recording sections are mounted to the carriage 28, and the carriage 28 moves (or “scans”) back and forth in a direction (“main scanning direction” in the following) that is substantially perpendicular to the carrying direction of the roll paper P (referred to as “sub-scanning direction” in the following). The metal pull belt 32 is driven by the carriage motor 30 and makes the carriage 28 move.

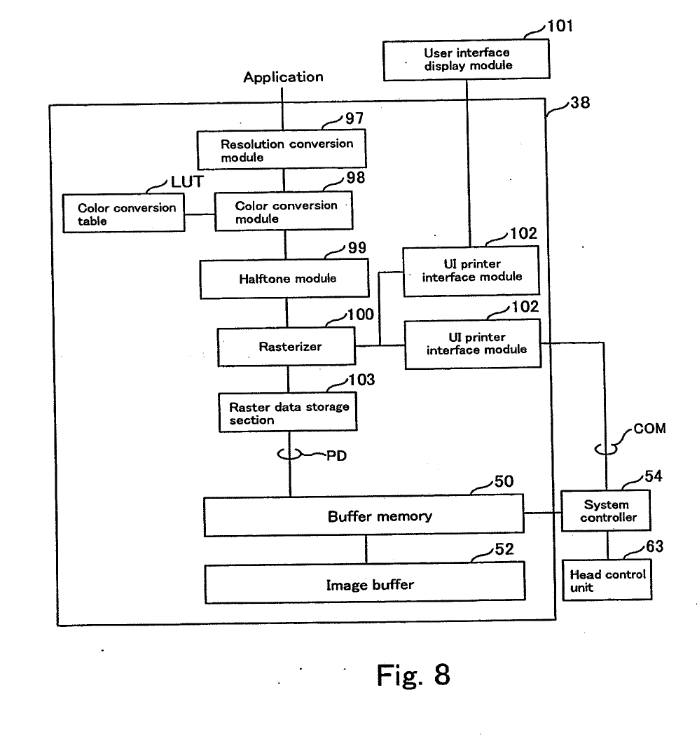

In the present embodiment, the carriage 28 is provided with eight print heads 36 as recording sections, and these print heads 36 include a plurality of nozzles, which serve as the recording portions, from which ink is ejected. Under the control of later-explained head control units 63 (see FIG. 8), the print heads 36 eject ink from predetermined nozzles. On the face of the print heads 36 that opposes the roll paper P, there are a plurality of nozzles rows serving as recording portion rows, in which a plurality of nozzles are arranged in rows along the sub-scanning direction. These nozzle rows are lined up in the main scanning direction parallel to each other. In the present embodiment, the eight print heads 36 are arranged in pairs of two, forming four print head groups 69. The print head groups 69 are arranged on the carriage 28 spaced apart from each other in the vertical direction and the width direction. Moreover, as noted above, it is possible to treat the print heads 36 as recording sections, but is also possible to treat each of the four print head groups 69 as recording sections, and it is also possible to combine two print head groups arranged in vertical direction or two print head groups arranged in width direction and treat them as one recording section. The print heads 36, the print head groups, and the layout of the nozzles are explained further below.

The two guide rails 34 are arranged at the top and the bottom along the main scanning direction with a certain spacing in the sub-scanning direction between them, and are supported at their left and right end sides by a frame (not shown) serving as a base.

The carriage 28 is pulled by the pull belt 32 that is driven by the carriage motor 30, and is moved in the main scanning direction along the guide rails 34. Moreover, the carriage 28 is moved in the main scanning direction while the roll paper P is being fed with the print paper carrying section 5, and the roll paper P is printed by ejecting ink from the eight print heads 36 provided on the carriage 28.

The print paper carrying section 5 is disposed at the rear side of the two guide rails 34, and includes two paper supply units 7 serving as medium supply sections that are arranged to the left and to the right. Each of the paper supply units 7 includes a roll paper holding section 35, a roll paper carrying section 37, and a platen 26. The roll paper holding section 35 is arranged below the lower guide rail 341 and holds the roll paper P rotatably together with a holder 27. The roll paper carrying section 37 is arranged above the upper guide rail 342 and serves as a driving section for carrying the roll paper P. Over the platen 26, the roll paper P is carried between the roll paper holding section 35 and the roll paper carrying section 37. This platen 26, which is formed in one piece, is shared by the two paper supply units 7 and has a flat surface across the entire width of the roll paper P that is carried by the two paper supply units 7.

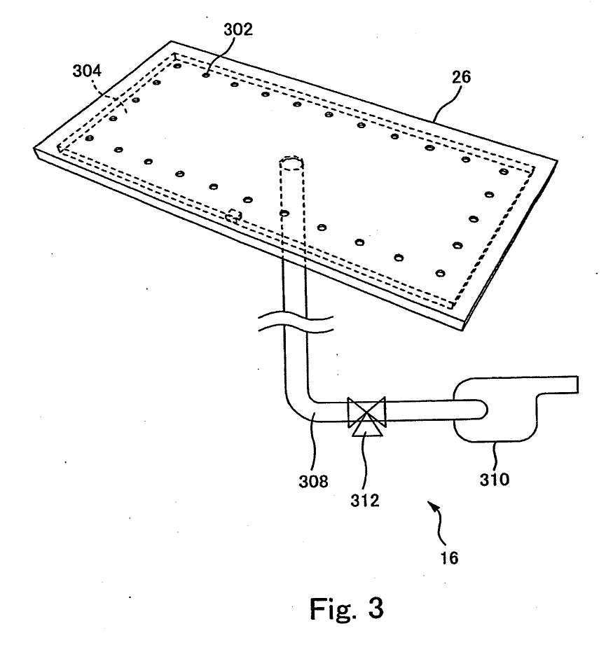

FIG. 3 is a schematic diagram illustrating a suction mechanism 16 in the platen 26. In the platen 26 shown in FIG. 3, a multitude of suction holes 302 are arranged in a loop along the periphery of the platen 26 on the side on which the roll paper P is carried. The holes 302 are in communication with a chamber 304 inside the platen 26. This chamber 304 is linked to the suction mechanism 16 that is arranged on the rear side of the platen 26 and sucks out the air inside the chamber 304. That is to say, the suction mechanism 16 is linked to the outside of the platen 26 via the multitude of suction holes 302 and the chamber 304.

The suction mechanism 16 has a suction blower 310 for sucking in the air within the chamber 304 to evacuate the chamber 304, a hose 308 connecting the suction blower 310 and the chamber 304, and a switch valve 312 provided in the middle of the hose 308. The switch valve 312 is constituted by an electromagnetic three-way valve that has an air release opening.

When the suction blower 310 is driven, the pressure within the chamber 304 drops, the roll paper P carried along the platen 26 is sucked via the numerous suction holes 302, and the roll paper P is carried along the platen 26 in a flat state without bending. It should be noted that by switching the switch valve 312, the suction mechanism 16 can let air into the chamber 304. Here, an example is shown in which the multitude of suction holes 302 are disposed in a loop along the periphery of the platen 26. However, they may also be disposed at an equal spacing over the entire surface of the platen 26, for example. This would allow the roll paper P to be adequately sucked to the entire surface, and has the benefit that crumpling, for example, is less likely to occur.

The holder 27 has shaft members 27a serving as rotation shafts holding the roll paper P. The shaft members 27a of the two paper supply units 7 arranged to the left and right are linked via a clutch 33 in the center. Guide disks 27b for preventing undulation of the supplied roll paper P are disposed on both sides of the linked shaft members 27a.

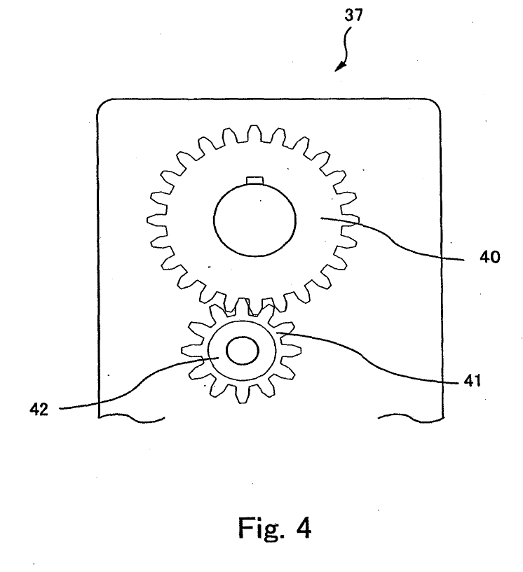

FIG. 4 is a cross-sectional view taken along line A-A in FIG. 1, and shows a driving force transmission section of the roll paper carrying section 37. The roll paper carrying section 37 has paper feed rollers (SMAP rollers) 24 serving as a supply section for carrying the roll paper P, clamping rollers 29 arranged in opposition thereto and clamping the roll paper P with the paper feed rollers 24, carry motors 31 serving as a driving section for driving the paper feed rollers 24, driving gears 40 arranged on a shaft of the carry motors 31, relay gears 41 meshing with the driving gears 40 and provided on the shafts of the paper feed rollers 24, and clutches 42 inserted between the relay gears 41 and the shafts of the paper feed rollers 24. The shafts of the paper feed rollers 24 of the two paper supply units 7 arranged to the left and right are disengageably linked via a clutch 43 arranged at the center.

That is to say, the roll papers P that are held by the respective holders 27 of the two paper supply units 7 are clamped between the paper feed rollers 24 and the clamping rollers 29. Then, when the clutch 33 between the holders 27 and the clutch 43 between the paper feed rollers 24 of the two paper supply units 7 are disengaged, the roll papers P can be carried independently along the platen 26 by each of the carry motors 31 for each paper supply unit 7. Therefore, the roll papers P that are carried by the left and right paper supply units 7 can be carried at different carry speeds and different carry amounts. Moreover, when the clutch 33 between the holders 27 and the clutch 43 between the paper feed rollers 24 are engaged, the clutch 42 of one of the relay gears 41 that are disposed in the transmission path of the two carry motors 31 is disengaged. Thus, it becomes possible to carry the roll papers P of the two paper supply units 7 at the same speed and the same carry amount by the driving force of the carry motor 31, which is transmitted by the other relay gear 41. In this case, by setting on the holders 27 a wide roll paper stretching across the holders 27 of the two paper supply units 7, the two paper supply units 7 can be operated as one unit, and it becomes possible to carry a wide roll paper. That is to say, the driving force of the carriage motor 31 is transmitted to the paper feed rollers 24 with the driving gear 40 and the relay gear 41 serving as the transmission path, and the clutch 42 functions as a driving force blocking section that blocks the transmission path of the driving force. Moreover, when using the two paper feed rollers 24 and the two holders 27 independently, the clutches 33 and 43 arranged between them also serve as driving force blocking sections.

### ===Configuration of the Print Heads===

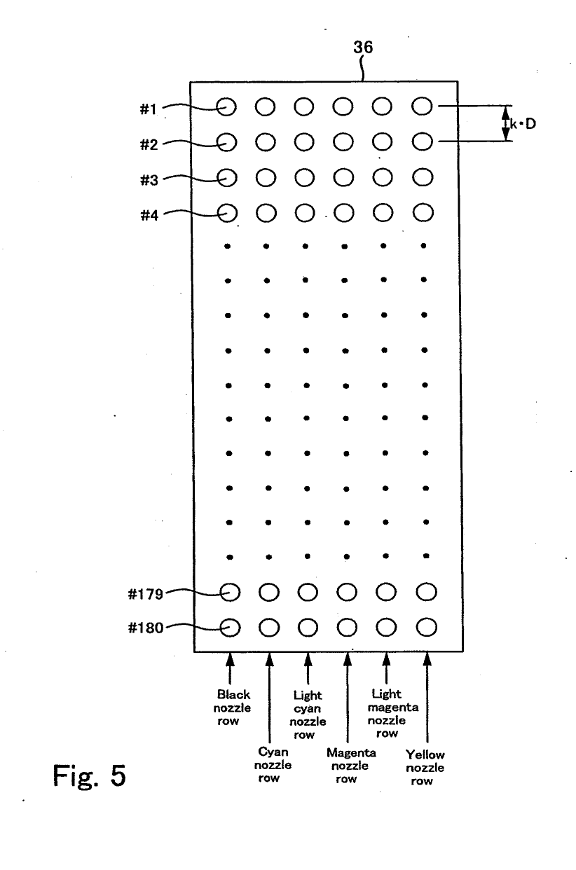

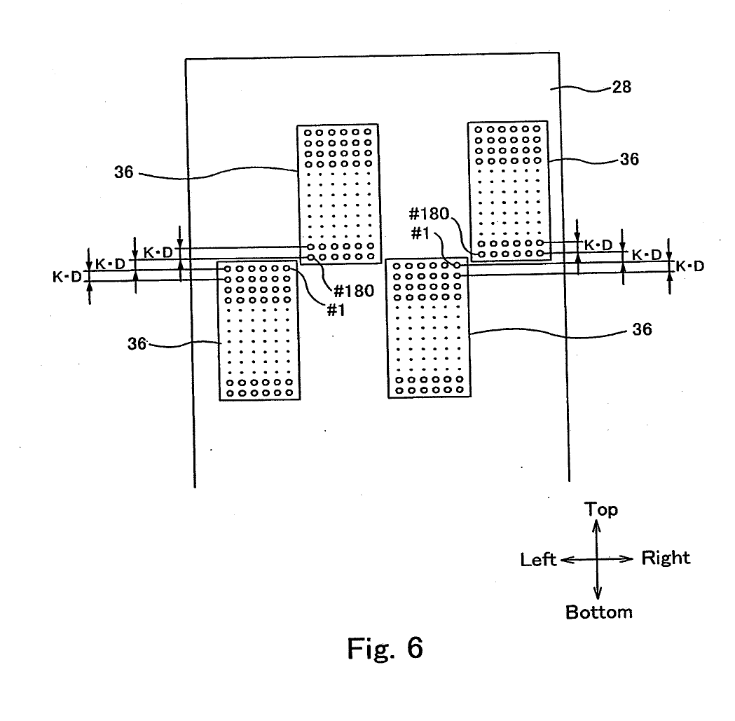

Next, the configuration of the print heads 36 is described using FIGS. 1, 5 and 6. FIG. 5 is an explanatory diagram illustrating the layout of the nozzles of the print heads 36. FIG. 6 is a diagram showing the arrangement of a plurality of adjacent print heads 36, and the positional relationship between the nozzle rows of these print heads 36.

As shown in FIG. 5, each of the print heads 36 has six nozzle rows serving as recording portion rows, in which a plurality of nozzles are arranged on a straight line in the sub-scanning direction. In the present embodiment, a row is arranged for each color of ink that is ejected, that is, there are a black nozzle row, a cyan nozzle row, a light cyan nozzle row, a magenta nozzle row, a light magenta nozzle row, and a yellow nozzle row. However, there is no limitation to this arrangement.

The black nozzle row has 180 nozzles, namely nozzles #1 to #180. Each of these nozzles is provided with a piezoelement (not shown) as a driving element for driving the nozzle and making it eject ink droplets. The nozzles #1, . . . , #180 of the black nozzle row are arranged at a constant nozzle pitch k·D in the sub-scanning direction. Here, D is the dot pitch in the sub-scanning direction, and k is an integer of 1 or greater. The dot pitch D in the sub-scanning direction is equal to the pitch of the main scan lines (raster lines). Hereinafter, the integer k expressing the nozzle pitch k·D is referred to simply as the “nozzle pitch k.” In the example of FIG. 5, the nozzle pitch k is four dots. The nozzle pitch k, however, may be set to any integer.

The above-described explanations also apply for the cyan nozzle row, the light cyan nozzle row, the magenta nozzle row, the light magenta nozzle row, and the yellow nozzle row. That is, each of these nozzle rows has 180 nozzles #1 to #180 arranged at a constant nozzle pitch k·D in the sub-scanning direction.

During printing, droplets of ink are ejected from the nozzles as the roll paper P is carried intermittently for a predetermined carry amount by the print paper carrying section 5 while the carriage 28 is moved in the main scanning direction during these intermittent carryings. However, depending on the print mode, not all of the nozzles are used necessarily, and there may also be instances in which only some of the nozzles are used.

Of the eight print heads 36 with which the carriage 28 is provided, four print heads 36 are arranged above the pull belt 32 and the remaining four print heads 36 are arranged below the pull belt 32. The positional relation in the four upper and lower print heads 36 is the same; therefore, here, only the positional relation of the upper four print heads 36 is explained as an example.

The four printing heads 36 are arranged in two vertical levels with two printing heads 36 each. The two upper print heads 36a and 36b, as well as the two lower print heads 36c and 36d, are spaced apart from each other in the lateral direction at a length that is approximately equal to the width of the print head 36. The upper right print head 36b on the right is located at the right end of the carriage 28. The lower print head 36c on the left is located at the left end of the carriage 28. That is, among the four print heads 36a, 36b, 36c, and 36d, the two print heads 36a and 36c on the left form a pair and the two print heads 36b and 36d on the right form another pair. In each pair of print heads 36, the print heads 36c and 36d on the left are located on the lower side, and the print heads 36a and 36b on the right are located on the upper side; that is, the four print heads 36 are in a staggered arrangement.

Moreover, as shown in FIG. 6, as for these four print heads 36, the lowermost nozzle #180 of each nozzle row in each of the upper print heads and the uppermost nozzle #1 of each nozzle row in each of the lower print heads are arranged at a pitch equal to the nozzle pitch of each nozzle row. That is, as for the two print heads 36a and 36c arranged on the left, the space, in the vertical direction, between the lowermost nozzle #180 (the rearmost nozzle in the paper carry direction) of each nozzle row in the upper right print head 36a and the uppermost nozzle #1 (the foremost nozzle in the paper carrying direction) of each nozzle row in the lower left print head 36c is arranged so that it is equal to the nozzle pitch k·D. In the same way, as for the two print heads 36b and 36d arranged on the right, the space, in the vertical direction, between the lowermost nozzle #180 of each nozzle row in the upper right print head 36b and the uppermost nozzle #1 of each nozzle row in the lower left print head 36d is arranged so that it is equal to the nozzle pitch k·D. Therefore, assuming that the two left print heads 36a and 36c form a print head group and the two right print heads 36b and 36d form another print head group, when each nozzle row in each print head group forms dots on the roll paper P at the same position in the main-scanning direction during one scan movement of the carriage, the dots formed by the nozzle rows of the two print heads 36 in the same group will form a continuous line at a constant pitch. That is, by controlling the timing to eject ink from the nozzle rows of the two print heads 36 in the same group, it becomes possible to assume that the nozzle rows are in one continuous nozzle row. In this way, it becomes possible to print at high speed even when printing a large image on a large-size print paper.

Moreover, it is possible to print different images at high speed by scanning the carriage 28 back and forth such that the two print head groups pass over different roll papers set up to the left and right, printing on one roll paper with one print head group and printing on the other roll paper with the other print head group. In this case, it becomes possible to simultaneously print images on the two roll papers P arranged in the two roll paper carrying sections 37, and to attain even higher speed, by arranging the spacing between the two print head groups arranged on the left and right such that the spacing between the nozzle row on the left side of each print head 36 is substantially the same as the distance between the left edge of each roll paper P that is carried by each of the two roll paper carrying sections 37 arranged to the left and right, and scanning the carriage 28 back and forth.

It should be noted that in FIG. 5, the ink colors of each of the nozzle rows were, in order from the left side in the figure, the black nozzle row, the cyan nozzle row, the light cyan nozzle row, the magenta nozzle row, the light magenta nozzle row, and the yellow nozzle row; however, this is not a limitation, and it is also possible for the ink colors of each nozzle row to be arranged in a different order.

### ===Example of the Overall Configuration of the Printing System===

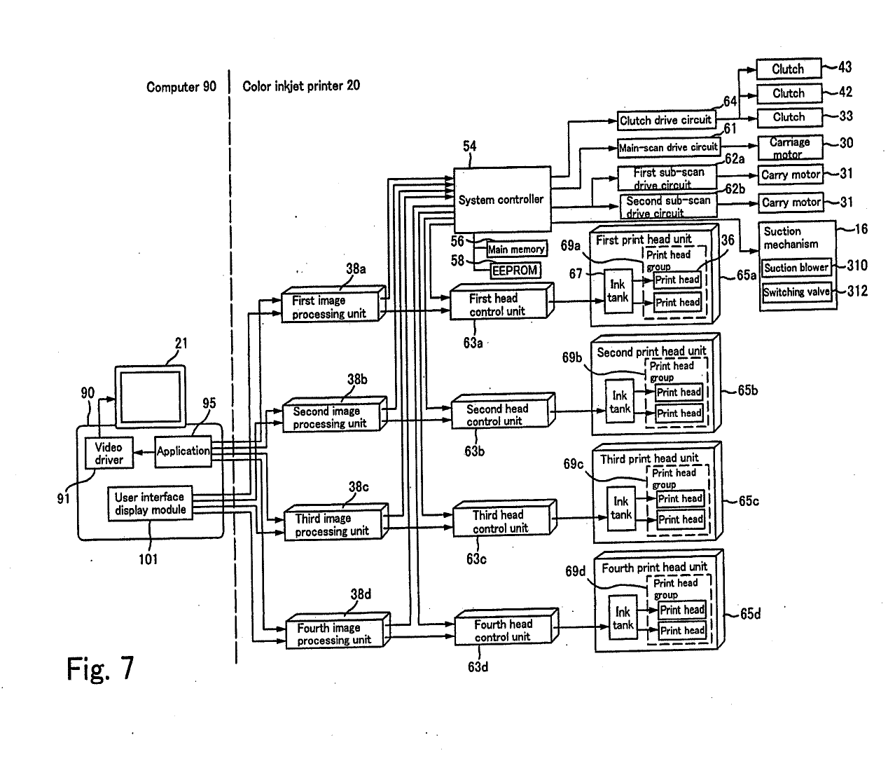

Next, an example of the overall configuration of the printing system is described with reference to FIG. 7 and FIG. 8. FIG. 7 is a block diagram showing the configuration of a printing system provided with the color printer 20 described above. FIG. 8 is a block diagram showing the configuration of an image processing unit 38.

This printing system is provided with a computer 90 and the color printer 20, which is an example of a recording apparatus. It should be noted that the printing system including the color printer 20 and the computer 90 can also be in a wide sense referred to as the “recording apparatus.” This system is made of the computer 90, the color printer 20, a display device such as a CRT 21 or a liquid crystal display device (not shown), input devices such as a keyboard and a mouse (not shown), and a drive device (not shown) such as a flexible drive device or a CD-ROM drive device.

In the computer 90, an application program 95 is executed under a predetermined operating system. The operating system includes a video driver 91, and the application program 95, which is for retouching images, for example, carries out desired processing with respect to images to be processed, and also displays the images on the CRT 21 through the video driver 91.

The color printer 20 includes image processing units 38, a system controller 54, a main memory 56, and an EEPROM 58. Print data etc. is input from the application program 95 into the image processing units 38, which serve as information generators. The system controller 54 controls the operation of the overall color printer 20. Further connected to the system controller 54 are a main-scan drive circuit 61 for driving the carriage motor 30, a first and a second sub-scan drive circuits 62a and 62b for driving the two carry motors 31a and 31b and arranged in correspondence thereto, and head control units 63 serving as controllers for controlling the print heads 36.

As shown in FIGS. 1, 2 and 7, the color printer 20 has a plurality of print heads 36. In this embodiment, the number of print heads 38 is eight, and they are arranged in four print head groups 69 of two print heads each. That is to say, there are a first print head group 69a (positioned on the upper left in FIG. 1), a second print head group 69b (positioned on the upper right in FIG. 1), a third print head group 69c (positioned on the lower left in FIG. 1), and a fourth print head group 69d (positioned on the lower right in FIG. 1). As shown in FIG. 7, each of the print head groups 69 forms a print head unit 65, that is, a first print head unit 65a, a second print head unit 65b, a third print head unit 65c, and a fourth print head unit 65d. Each of the print head units 65 is configured such that it is attachable to, and detachable from, the printer main body. Moreover, each of the print head units 65 is provided with an ink tank 67 that accommodates the ink that is supplied to the print heads 36 of that print head unit 65.

The color printer 20 also has one of the above-described head control units 63 for each of the print head groups 69. Consequently, in the present embodiment, a first head control unit 63a corresponding to the first print head group 69a, a second head control unit 63b corresponding to the second print head group 69b, a third head control unit 63c corresponding to the third print head group 69c, and a fourth head control unit 63d corresponding to the fourth print head group 69d are provided. Moreover, the head control units 63 are arranged in separate units, and these head control units 63 are configured such that they are attachable to, and detachable from, the printer main body.

Similarly, also one of the above-mentioned image processing units 38 is arranged for each of the print head groups 69. That is to say, in the present embodiment, a first image processing unit 38a corresponding to the first print head group 69a, a second image processing unit 38b corresponding to the second print head group 69b, a third image processing unit 38c corresponding to the third print head group 69c, and a fourth image processing unit 38d corresponding to the fourth print head group 69d are provided. Moreover, the image processing units 38 are arranged in separate units, and these image processing units 38 are configured such that they are attachable to, and detachable from, the printer main body.

When the application program 95 issues a print command, the image processing units 38 provided in the color printer 20 as an example of information generators receive image data from the application program 95 and convert the data into print data PD, which serves as recording information. As shown in FIG. 8, the image processing sections 38 are internally provided with a resolution conversion module 97, a color conversion module 98, a halftone module 99, a rasterizer 100, a UI printer interface module 102, a raster data storage section 103, a color conversion lookup table LUT, a buffer memory 50, and an image buffer 52.

The role of the resolution conversion module 97 is to convert the resolution of the color image data formed by the application program 95 into the print resolution. The image data whose resolution has been thus converted at this point is still image information made of the three color components RGB. Referencing the color conversion look-up table LUT, the color conversion module 98 converts for each pixel the RGB image data into multi-gradation data of a plurality of ink colors that can be used by the color printer 20.

The multi-gradation data that has been color converted has, for example, 256 gradation values. The halftone module 99 executes so-called halftone processing to generate halftone image data. The halftone image data is arranged by the rasterizer 100 into a desired data order, and is output as the final print data PD to the raster data storage section 103.

On the other hand, the user interface display module 101 provided in the computer 90 has the function to display various types of user interface windows related to printing and the function to receive input from the user through these windows. For example, the user can specify the type and size of the print paper, or the print mode, for example, with the user interface display module 101.

The UI printer interface module 102 functions as an interface between the user interface display module 101 and the color printer 20. It interprets instructions given by users through the user interface and sends various commands COM to the system controller 54, for example, or conversely, it interprets commands COM received from the system controller 54, for example, and executes various displays on the user interface. For example, the instructions regarding the type or the size of the print paper, for example, that are received by the user interface display module 101 are sent to the UI printer interface module 102, which interprets these instructions and sends commands COM to the system controller 54.

The UI printer interface module 102 also functions as a print mode setting section. That is, the UI printer interface module 102 determines the print mode, which is the recording mode, based on print information received by the user interface display module 101, namely information about the resolution of the printed image and the nozzles used for the printing, and information related to the data indicating the sub-scanning feed amount. Then, print data PD corresponding to the print mode is generated by the halftone module 99 and the rasterizer 100, and output to the raster data storage section 103. The print data PD that is output to the raster data storage section 103 is temporarily stored in the buffer memory 50, converted into data corresponding to the nozzles, and stored in the image buffer 52. The system controller 54 of the color printer 20 controls the main-scan drive circuit 61, the first and a second sub-scan drive circuits 62a and 62b, the head control units 63, and so forth, based on the information of the commands COM that are output by the UI printer interface module 102, and performs printing by driving the nozzles for the various colors that are provided on the print heads 36 based on the data from the image buffer 52. Here, as print modes, there are, for example, a high image-quality print mode in which dots are recorded using the so-called interlace mode, and a high-speed mode in which dots are recorded without using this mode.

### ===Operation of the Printing System===

The following is an explanation of the operation of the above-described printing system. First, the user sets roll paper of predetermined size in the holders, and specifies information regarding the print mode etc. with the user interface display module 101. It is also possible to specify in the user interface display module 101 the printing of a plurality of images with each of the print head groups 69. Here, as an example of the printing operation with this printing system, first, the operation is explained for the case that a single roll of paper is set across the left and right holders 27, and four different images are printed by the four print head groups 69 in the same print mode.

That is to say, an instruction is given to the effect that a first image is printed with the print heads 36 belonging to the first print head group 69a, a second image is printed with the print heads 36 belonging to the second print head group 69b, a third image is printed with the print heads 36 belonging to the third print head group 69c, and a fourth image is printed with the print heads 36 belonging to the fourth print head group 69d, all images being printed on one print paper according to the same print mode. In this case, since a single print paper is printed, the clutch 33 arranged between the left and right holders 27 as well as the clutch 43 arranged between the left and right paper feed rollers 24 are engaged by the clutch driving section 64. On the other hand, the clutch 42 of one of the relay gears that are interposed between the left and right paper feed rollers 24 and the carry motors 31 to which the left and right paper feed rollers 24 are respectively connected is disengaged, and the other carry motor 31 and the paper feed roller 24 linked to it are linked. The instructions received by the user interface display module 101 are sent to the UI printer interface modules 102 provided in the four image processing units 38a, 38b, 38c, and 38d, and these UI printer interface modules 102 interpret the instructed orders and send commands COM to the system controller 54.

Next, the user gives the application program 95 or the like an instruction to perform printing. When the application program 95, which has received this instruction, issues a print command, the above-mentioned four image processing units 38a, 38b, 38c, and 38d respectively receive the image data of the four images from the application program 95, and after the image data has been converted into print data PD, it is sent to the buffer memory 50. The image processing units 38a, 38b, 38c, and 38d send the print data PD corresponding respectively to the first, second, third, and fourth images to the image buffer 52, after receiving the print data PD with their buffer memories 50.

Moreover, the image processing units 38a, 38b, 38c, and 38d send the above-mentioned commands COM to the system controller 54. Based on the information received from the image processing units 38a, 38b, 38c, and 38d, the system controller 54 sends control signals to the main scan drive circuit 61, the first or second sub-scan drive circuit 62, and the above-mentioned four head control units 63a, 63b, 63c, and 63d.

Further, in accordance with the control signals from the system controller 54, the head control units 63a, 63b, 63c, and 63d read out the print data of each color component from the image buffers 52 in the image processing units 38a, 38b, 38c, and 38d corresponding to the respective head control units 63. Then, the head control units 63a, 63b, 63c, and 63d control the print heads 36 belonging to the respectively corresponding print head groups 69a, 69b, 69c, and 69d in accordance with the data that has been read out.

Then, while controlling the carry motor 31 with one of the sub-scan drive circuits 62 to feed the roll paper P, the carriage motor 30 is controlled with the main scan drive circuit 61 so as to move the carriage 28 in the main scanning direction, and ink is ejected from the print heads 36 controlled by the respective print head control units 63a, 63b, 63c, and 63d, thus printing on the roll paper P.

In these explanations of the operation of the printing system, an example was given in which a single roll of paper is set across the left and right holders 27, and four images are printed in the same print mode, but also when separate rolls of paper are set in the left and right holders 27, it is possible to print images in the same print mode onto these rolls of paper by a similar operation.

The following is an explanation of an example in which separate rolls of paper are set in the left and right holders 27, and four different images are printed in different print modes by the respective four print head groups 69.

That is to say, the images printed by the first print head group 69a and the third print head group 69c, which are located at the left side of the carriage 28 in FIG. 1, and the images printed by the second print head group 69b and the fourth print head group 69d, which are located at the right side of the carriage 28, are printed in different print modes. For example, the first print head groups 69a and the third print head group 69c may print in the high-image quality mode, that is, the interlace mode, and the second print head groups 69b and the fourth print head group 69d may print with a high-speed mode, that is, the so-called band feed mode. In this case, printing in the interlaced mode and printing in the band feed mode is different with regard to the carry amount of the roll paper between each scan movement of the carriage 28. Therefore, it is not possible to carry the two roll papers set in the left and right holders 27 with a single carry motor 31. For this reason, the clutch 33 arranged between the left and right holders 27 and the clutch 43 arranged between the left and right paper feed rollers 24 are disengaged by the clutch driving section 64. On the other hand, the clutches 42 of the relay gears interposed between the two (left and right) paper feed rollers 24 and the carry motors 31 connected to the respective paper feed rollers 24 are both engaged. Thus, the left and right paper feed rollers 24 independently carry the roll paper as the respectively connected carry motors 31 are driven by the sub-scan driving sections 62a and 62b.

Based on the instructions received by the user interface display module 101, print data PD is generated, and while the roll papers P are fed forward under the control of the sub-scan drive circuits 62 respectively corresponding to the two carry motors 31, the carriage 28 is moved in the main scanning direction by the carriage motor 30 controlled by the main-scan drive circuit 61, and ink is ejected from the print heads 36 under the control of the print head control units 63a, 63b, 63c, and 63d, based on the print data PD. Thus, the operation of printing on the roll paper P is similar to the foregoing example.

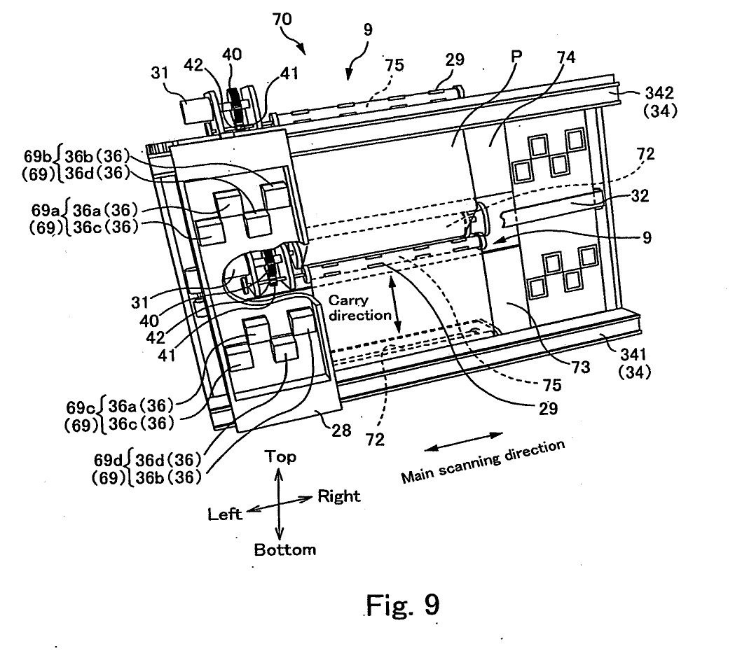

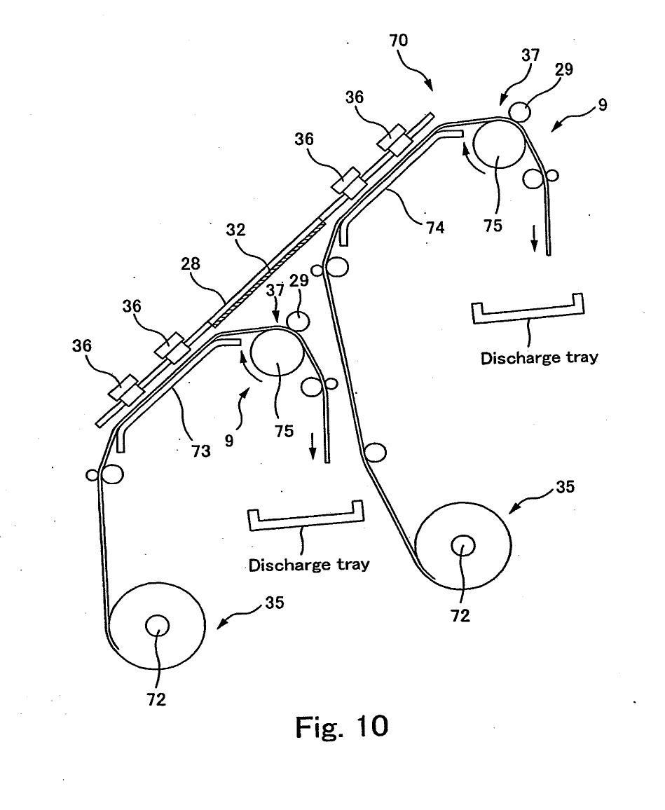

The following is an explanation of a second embodiment of the present invention, with reference to FIGS. 9 and 10. FIG. 9 is a perspective view of a color printer according to the second embodiment, and FIG. 10 is a diagrammatic cross-sectional view of FIG. 9. In the following, the same reference numerals have been assigned to corresponding structural members of the foregoing embodiment, and duplicate explanations have been omitted.

As shown in the figures, the color printer 70 according to the second embodiment is an example of a color printer in which two paper supply units 9 are arranged one above the other.

The holders 72 of the two paper supply units 9 are both formed by members having a length that is substantially equal to a length amounting to two of the holders 27 of the first embodiment. Moreover, two platens 73 and 74 are arranged spaced apart from one another with a certain space between them, one above the other on the rear side of the pull belt 32, which is disposed approximately in the middle between the upper and lower guide rails 34.

Moreover, the holder 72 of the lower paper supply unit 9 is provided below the lower guide rail 341, as in the first embodiment, and is supported such that it can rotate together with roll paper P. This roll paper P is carried along the lower platen 73, passes through the space between the two platens 73 and 74, and is carried to the rear side of the lower platen 73. A paper feed roller (SMAP roller) 75 having a similar length as the holder 72 and clamping rollers 29 opposing the paper feed roller 75 are provided near the upper edge of the lower platen 73. The paper feed roller 75 is connected to a carry motor 31.

The holder 72 of the upper paper supply unit 9 is provided below the lower edge of the upper platen 74, and is supported such that it can rotate together with roll paper P. A paper feed roller 75 and clamping rollers 29 are provided above the upper guide rail 342, and this paper feed roller 75 is driven by a carry motor 31. The roll paper is carried from between the two platens 73 and 74 along the upper platen 74, and then from the upper end of the upper platen 74 to its rear side.

In this case, the images printed by the first print head group 69a and the second print head group 69b, which are located at the upper side of the carriage 28, and the images printed by the third print head group 69c and the fourth print head group 69d, which are located at the lower side of the carriage 28, can be printed in different print modes. For example, the first print head group 69a and the second print head group 69b may print in the high image-quality mode, and the third print head group 69c and the fourth print head group 69d may print in a high-speed mode. In this case, the roll papers are carried independently by driving the carry motors 31, which are respectively connected to the upper and lower paper feed rollers 75, with the corresponding sub-scanning driving sections 62, and in this way, it becomes possible to print images according to different print modes with the upper and lower print head groups 69. Moreover, it is possible to print four images in the same print mode on one print paper at the same time by clamping, between the upper paper feed roller 75 and the clamping rollers 29, the roll paper that has been set in the lower holder 72, and ejecting ink with the four print head groups 69 while the upper paper feed roller 75 carries the roll paper. Further, with such a configuration, it is possible to achieve increased speed in printing by printing a single image across the entire region of the roll paper, using four print head groups 69.

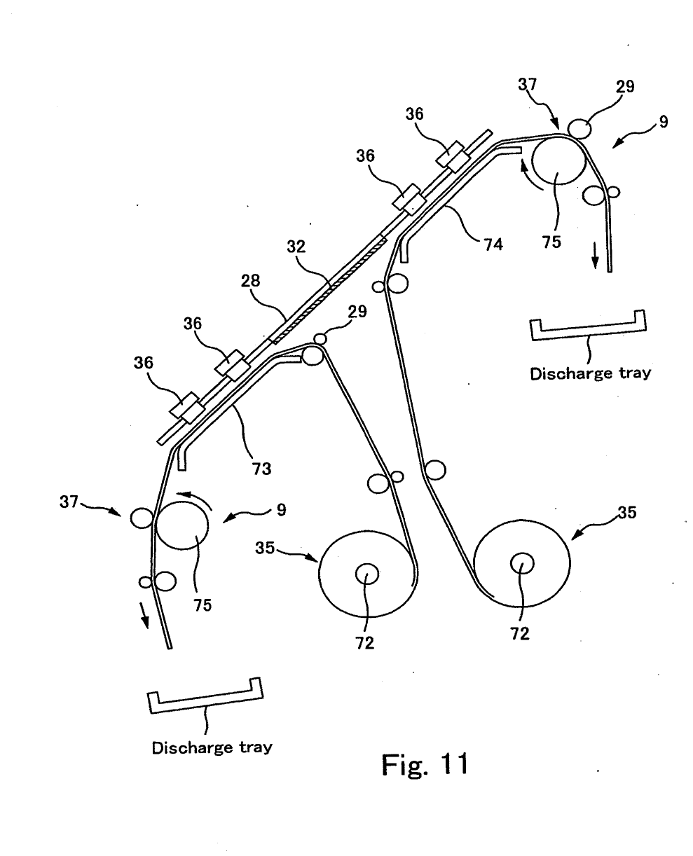

FIG. 11 is a diagrammatic cross-sectional view showing an outline of a color printer according to the second embodiment.

In the above-described second embodiment, an example was shown in which both of the two paper supply units 9 that are disposed one above the other are provided with a roll paper holding section 35 at their lower side and with a roll paper carrying section 37 at their upper side, and the roll paper is carried upward from below. However, as shown in FIG. 11, it is also possible to adopt a configuration in which the lower paper supply unit 9 is provided with a roll paper holding section 35 on its upper side and with a roll paper carry section 37 on its lower side.

That is to say, in this case, both roll papers that are supplied from the two rolls set on the rear side are carried to the front surface from between the two platens 73 and 74 that are arranged at the top and the bottom, and one of the roll papers is carried by the upper roll paper carrying section 37 along the upper platen 74, whereas the other the roll papers is carried by the lower roll paper carrying section 37 along the lower platen 73. Thus, by carrying one of the roll papers that are supplied from the two rolls in upward direction and the other one in downward direction, it is possible to discharge the printed roll papers at the top and at the bottom of the color printer 20. This means, it becomes possible to discharge the print output at positions where it can be easily retrieved by the user. Therefore, a color printer with better operability can be provided.

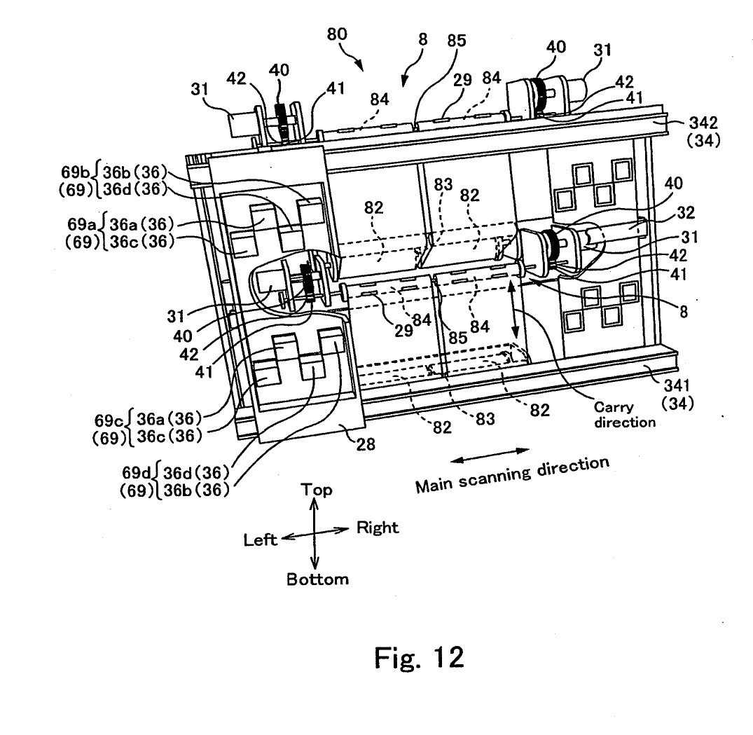

A third embodiment of the present invention is explained with reference to FIG. 12. FIG. 12 is a perspective view showing a color printer 80 according to the third embodiment.

As shown in FIG. 12, the paper supply unit 8 of the third embodiment, which are arranged at the top and the bottom as in the second embodiment, are configured substantially the same as in the first embodiment. That is to say, in each of the upper and lower paper supply units 8, two holders 82 arranged to the left and right are linked by a clutch 83 at the center of a shaft of each holder, and a shaft of each paper feed roller (SMAP roller) 84 arranged to the left and right are linked by a clutch 85 at the center. Moreover, each of the units 8 includes driving gears 40 disposed on the shafts of the carry motors 31 for rotating the paper feed rollers 84, relay gears 41 that mesh with the driving gears 40 and that are disposed on the shafts of the paper feed rollers 84, and clutches 42 that are interposed between the relay gears 41 and the paper feed rollers 84.

That is to say, by disengaging both the clutches 83 between the holders 82 arranged to the left and right, as well as the clutches 85 between the paper feed rollers 84 arranged to the left and right, of the upper and lower paper supply units 8, the paper feed rollers 84 can carry the roll papers independently with the corresponding carry motors 31 connected to the paper feed rollers 84. Moreover, it becomes possible to print images in different print modes, with the first to fourth print head groups 69a to 69d, on each of the roll papers that is carried by the paper supply units 8 corresponding to the respective print head groups. In this case, it is possible to print on wide roll paper by engaging the clutches 83 and 85 between the holders 82 and the paper feed rollers 84 arranged to the left and to the right at the top and the bottom. It is also possible to print simultaneously in different print modes on roll papers of different width by setting two rolls of narrow paper in one of the upper and lower paper supply units 8, and setting one roll of wide paper in the other paper supply unit 8.

In the above-described embodiment, images are printed on the roll paper P in the order in which the processing of the first image, the second image, the third image, and the fourth image with the respective image processing units 38a, 38b, 38c, and 38d is finished. That is to say, the color printer does not wait until all of the image processing for the four images has finished before printing the images on the roll paper P, but the first to fourth images are independently image-processed and printed on the roll paper P. With this color printer, roll paper is supplied to each of the recording sections, for example each of the print head groups 69, by the paper supply units 7, 8, or 9 that are provided in correspondence with the print head groups, the print data is generated by the image processing units corresponding to the respective print head groups 69, the print head groups 69 are controlled independently by the head control units 63 corresponding to the respective print head groups 69, thus making it possible to print different images in different print modes in the order in which the print data PD is generated.

In the above-mentioned embodiment, an example was shown in which roll paper that is arranged across two, left and right, paper supply units 7 is printed while driving only one of the carry motors 31 of the paper supply units 7 on which the roll paper is arranged. However, it is also possible to drive both of the carry motors 31 of the two paper supply units 7 and let the carry motors 31 operate together to supply the roll paper. In this case, it becomes possible to carry the roll paper more reliably.

It should be noted that in the foregoing, the number of print heads was eight, but there is no limitation to this, and any plural number of print heads may be used.

Moreover, in the foregoing, the eight print heads have been divided into four print head groups of two print heads each, but there is no limitation to this kind of division. For example, it is also possible to divide the eight print heads into two print head groups by respectively taking four print heads arranged in the sub-scanning direction as one group, or to divide them into two print head groups by respectively taking the four print heads arranged above and below the pull belt 32 as one group. Moreover, it is also possible to divide the eight print heads into three print head groups, and let two of those print head groups have three print heads each and let the remaining one print head group have two print heads. Moreover, the print head groups may also have only one print head.

Moreover, in the foregoing, the image processing unit shown in FIG. 8 was given as one example of the image processing means, but there is no limitation to this, and any image processing means is possible as long as it can process the images that are output from the application software or the like in order to, for example, send out print data to the head control units 63. For example, it is not necessarily required to look up the color conversion table when performing the color conversion with the color conversion modules 98, and it is also not necessarily required to execute a halftone processing when carrying out the image processing. Moreover, the image processing means do not have to include a function related to the user interface, such as the UI printer interface module 102.

### Other Embodiments

In the foregoing, a recording apparatus etc. according to the present invention was explained based on embodiments, but the above-described embodiments of the present invention are merely to facilitate the understanding of the present invention, and are in no way meant to limit the present invention. Needless to say, modifications and improvements not parting from the spirit of the present invention are possible, and equivalents thereof are intended to be embraced in the present invention.

The above embodiments have been explained by taking print paper as an example of the recording medium, but the present invention is not limited to this. For example, technology like that of the above embodiments can also be applied to, for example, color filter manufacturing devices, dyeing devices, fine processing devices, semiconductor manufacturing devices, surface processing devices, three-dimensional shape forming machines, liquid vaporizing devices, organic EL manufacturing devices (particularly macromolecular EL manufacturing devices), display manufacturing devices, film formation devices, or DNA chip manufacturing devices. Moreover, methods therefor and manufacturing methods thereof using the same also fall within the range of application of the present invention. When the technology of the present invention is applied to such fields, then savings in material, processes, and costs compared to conventional cases can be achieved in those fields, because it is possible to directly eject (directly render) a liquid on the target material.

Moreover, color inkjet printers that print using ink were explained as examples of printing apparatuses, but the present invention can also be applied to monochrome inkjet printers. Furthermore, the above-described embodiments were explained for the case of inkjet printers so that ink, such as dye ink or pigment ink, was described as the liquid that is ejected from the nozzles. The liquid, however, is not limited to inks. For example, it is also possible to use, in accordance with the above-mentioned apparatus types, metallic materials, organic materials (in particular polymeric materials), magnetic materials, conductive materials, wiring materials, film forming materials, electronic ink, machining liquids, genetic solutions, and so forth as the liquid (including water). Moreover, roll paper was described as an example of the print paper, but it is also possible to use A0 or B0 size paper or the like as the print paper.

Moreover, in the above embodiments, the print head groups formed print head units, and these print head units were attachable to, and detachable from, the printer body, but there is no limitation to this. Furthermore, in the above embodiments, the images that have been processed by the image processing units are printed, in the order in which their image-processing with the image processing units is finished, on the roll paper by ejecting ink from the print heads belonging to the print head groups corresponding to the image processing units with which the images have been processed, but there is no limitation to this. For example, it is also possible to start the printing of the images on the roll paper P after waiting until the image processing for all images has been finished.

What is claimed is:

1. A recording apparatus comprising:
a first supply section that supplies a recording medium;
a first transporting section that transports the recording medium in a transport direction;
a second supply section that supplies a recording medium, the second supply section being provided separately from the first supply section;
a second transporting section that transports the recording medium, the second transporting section being provided separately from the first transporting section and upstream of the first transporting section in the transport direction of the first transporting section;
a first recording section that records on the recording medium; and
a second recording section that records on the recording medium, the second recording section being provided upstream of the first recording section in the transport direction of the first transporting section,
the recording apparatus being capable of:
performing a first recording method that includes recording on the recording medium at the first recording section while transporting the recording medium by the first transporting section, the recording medium being supplied by the first supply section from between a recording position of the first recording section and a recording position of the second recording section, and recording on the recording medium supplied from the second supply section while transporting the recording medium by the second transporting section; and
performing a second recording method that includes simultaneously recording on the recording medium by the first recording section and the second recording section while transporting, by the first transporting section, the recording medium supplied from the second supply section.

2. The recording apparatus according to claim 1, further comprising:
a first controlling section that controls the first recording section; and
a second controlling section that controls the second recording section.

3. The recording apparatus according to claim 1, wherein the first recording section and the second recording section record based on recording information,
the recording apparatus further comprising information generating sections that generate the recording information provided in correspondence with the first recording section and the second recording section, respectively.

4. The recording apparatus according to claim 3, wherein the first recording section and the second recording section record on recording media supplied from the first supplying section and the second supplying section, respectively, in an order in which the recording information are generated by the respective information generating sections.

5. The recording apparatus according to claim 1, wherein the first recording section and the second recording section are capable of recording in different recording modes.

6. The recording apparatus according to claim 1, wherein
each of the first recording section, the second recording section and another recording section has a recording portion row in which a plurality of recording portions are arranged in a row at an equal pitch in a supply direction of the recording medium, and
a distance between a rearmost recording portion, in the supply direction, of the recording portion row of the other recording section adjacent to the first recording section in a direction orthogonal to the supply direction, and a foremost recording portion, in said supply direction, of the recording portion row of the first recording section is equal to the pitch.

7. The recording apparatus according to claim 1, wherein the first recording section and the second recording section record on the recording medium while moving integrally in a direction intersecting a direction in which the recording medium is transported.

8. The recording apparatus according to claim 1, further comprising:
a first controlling section that controls the first recording section; and
a second controlling section that controls the second recording section,
wherein the first recording section and the second recording section record based on recording information,
the recording apparatus further comprising information generating sections that generate the recording information provided in correspondence with the first recording section and the second recording section, respectively,
wherein the first recording section and the second recording section record on recording media supplied from the first supplying section and the second supplying section, respectively, in an order in which the recording information are generated by the respective information generating sections,
wherein the first recording section and the second recording section are capable of recording in different recording modes,
wherein each of the first recording section, the second recording section and another recording section has a recording portion row in which a plurality of recording portions are arranged in a row at an equal pitch in a supply direction of the recording medium, and a distance between a rearmost recording portion, in the supply direction, of the recording portion row of the other recording section adjacent to the first recording section in a direction orthogonal to the supply direction, and a foremost recording portion, in said supply direction, of the recording portion row of the first recording section is equal to the pitch, and
wherein the first recording section and the second recording section record on the recording medium while moving integrally in a direction intersecting a direction in which the recording medium is transported.

9. A method for recording with a recording apparatus, the recording apparatus including:
a first supply section that supplies a recording medium;
a first transporting section that transports the recording medium in a transport direction;
a second supply section that supplies a recording medium, the second supply section being provided separately from the first supply section;
a second transporting section that transports the recording medium, the second transporting section being provided separately from the first transporting section and upstream of the first transporting section in the transport direction of the first transporting section;
a first recording section that records on the recording medium; and
a second recording section that records on the recording medium, the second recording section being provided upstream of the first recording section in the transport direction of the first transporting section,
the method comprising:
recording on the recording medium at the first recording section while transporting the recording medium by the first transporting section, the recording medium being supplied by the first supply section from between a recording position of the first recording section and a recording position of the second recording section, and recording on the recording medium supplied from the second supply section while transporting the recording medium by the second transporting section; and
simultaneously recording on the recording medium by the first recording section and the second recording section while transporting, by the first transporting section, the recording medium supplied from the second supply section.

10. The method according to claim 9, wherein the recording apparatus further includes:
a first controlling section that controls the first recording section; and
a second controlling section that controls the second recording section.

11. The method according to claim 9, wherein the first recording section and the second recording section record based on recording information, information generating sections that generate the recording information being provided in correspondence with the first recording section and the second recording section, respectively.

12. The method according to claim 11, wherein the first recording section and the second recording section record on recording media supplied from the first supplying section and the second supplying section, respectively, in an order in which the recording information are generated by the respective information generating sections.

13. The method according to claim 9, wherein the first recording section and the second recording section are capable of recording in different recording modes.

14. The method according to claim 9, wherein each of the first recording section, the second recording section and another recording section has a recording portion row in which a plurality of recording portions are arranged in a row at an equal pitch in a supply direction of the recording medium, and
a distance between a rearmost recording portion, in the supply direction, of the recording portion row of the other recording section adjacent to the first recording section in a direction orthogonal to the supply direction, and a foremost recording portion, in said supply-direction, of the recording portion row of the first recording section is equal to the pitch.

15. The method according to claim 9, wherein the first recording section and the second recording section record on the recording medium while moving integrally in a direction intersecting a direction in which the recording medium is transported.

16. The method according to claim 9, wherein the recording apparatus further includes:
a first controlling section that controls the first recording section; and
a second controlling section that controls the second recording section,
wherein the first recording section and the second recording section record based on recording information,
the recording apparatus further comprising information generating sections that generate the recording information provided in correspondence with the first recording section and the second recording section, respectively,
wherein the first recording section and the second recording section record on recording media supplied from the first supplying section and the second supplying section, respectively, in an order in which the recording information are generated by the respective information generating sections,
wherein the first recording section and the second recording section are capable of recording in different recording modes,
wherein each of the first recording section, the second recording section and another recording section has a recording portion row in which a plurality of recording portions are arranged in a row at an equal pitch in a supply direction of the recording medium, and a distance between a rearmost recording portion, in the supply direction, of the recording portion row of the other recording section adjacent to the first recording section in a direction orthogonal to the supply direction, and a foremost recording portion, in said supply direction, of the recording portion row of the first recording section is equal to the pitch, and
wherein the first recording section and the second recording section record on the recording medium while moving integrally in a direction intersecting a direction in which the recording medium is transported.
